(19) United States
(12) Patent Application Publication
(10) Pub. No.: US 2010/0287843 A1
(43) Pub. Date: Nov. 18, 2010

(54) DOOR HANDLE FOR REFRIGERATOR AND COMBINING STRUCTURE FOR DOOR HANDLE

(75) Inventor: Seung-Jin Oh, Changwon City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/522,524

(22) PCT Filed: Jan. 4, 2008
(86) PCT No.: PCT/KR08/00058

§ 371 Date: Apr. 26, 2010

(30) Foreign Application Priority Data
Jan. 9, 2007 (KR) 10-2007-0002575

(51) Int. Cl. E06B 7/28; E05B 1/00

(52) U.S. Cl. 49/460; 16/412

(57) ABSTRACT

To improve the strength of a door handle, facilitate decorating of a door handle, simplify assembly, and improve the outward appearance of not only a door handle but also a door, there is provided a door handle for a refrigerator including: a handle holder fixed to a side of a door of the refrigerator; a handle bar body formed to extend in one direction, with extended ends thereof fixed to the handle holder and having a catching rib respectively formed at either side thereof; and a handle cover disposed at a front of the handle bar body and catching on and supported by the catching ribs.

### TECHNICAL FIELD

1. The present disclosure relates to a door handle, and more particularly, to a door handle for a refrigerator and a combining structure for a door handle that may be applied to a door for opening and closing a storage compartment in a refrigerator.

2. Background Art

As a device that a user uses to open an internal compartment of any apparatus, a door generally has a door handle mounted thereon. Below, a refrigerator will be exemplarily described. A refrigerator has its interior configured as low temperature compartments to preserve items such as food placed inside at low temperatures and keep foods edible over extended periods. The inner compartments are kept sealed by means of doors, and may be opened when needed by a user through grasping a handle mounted on a door.

In more detail, storage compartments are defined within a main body of a refrigerator. The storage compartments may include a refrigeration compartment at the upper portion of the main body and a freezer compartment separated from and disposed below the refrigeration compartment. A pair of refrigeration compartment doors may be provided—one on either side at the front, upper portion of the main body—to selectively open and close the refrigeration compartment, and a freezer compartment door for selectively opening and closing the freezer compartment may be provided at the front, lower portion of the main body. The refrigeration compartment door and the freezer compartment door respectively have a door handle provided a predetermined distance from the outermost surface of the corresponding door. Of course, the predetermined distance is to allow a user to insert a hand therein to grasp the door handle.

Such door handles according to the related art are formed in elongated bar shapes which are made hollow to reduce weight. Accordingly, there is a need to reinforce the strength of such door handles and prevent deformation of the door handle shape during assembly. Also, in simple bar-type door handles according to the related art, the only means for exterior decoration thereof are painting the door handle in different colors, or using a different material for the door handle. Therefore, a limitation in being unable to satisfy consumer demands for more varied designs exists.

In this light, there is a pressing need for a structure that enables sufficient reinforcement of a door handle's strength, while also providing ways to make a door handle exterior more aesthetically pleasing.

### DISCLOSURE OF INVENTION

### Technical Problem

According to an object of the present disclosure, there are provided a door handle for a refrigerator and a combining structure for a door handle that allow a consumer to safely use the door handle through reinforcing its strength, while also allowing door handles, that present visual focal points to users, to be aesthetically decorated.

### Technical Solution

A door handle for a refrigerator according to the present disclosure includes: a handle holder fixed to a side of a door of the refrigerator; a handle bar body formed to extend in one direction, with extended ends thereof fixed to the handle holder and having a catching rib respectively formed at either side thereof; and a handle cover disposed at a front of the handle bar body and catching on and supported by the catching ribs.

A door handle for a refrigerator according to the present disclosure also includes: a handle holder fixed to a side of a door of the refrigerator; a handle bar coupled to the handle holder; a mounting groove provided through the handle bar being recessed at a predetermined location on the handle bar; and a sealing cover covering the mounting groove, and through which light passes.

A combining structure for a door handle according to the present disclosure includes: a door main body selectively opening an internal space; a side deco-bar covering a side edge portion of the door main body; a mounting bracket mounting the side deco-bar to the door main body; a handle holder fixed to the side deco-bar; and a handle bar coupled to the handle holder, for a user to grasp, wherein the handle bar comprises a handle bar body; and a separate handle cover covering a front of the handle bar body.

A combining structure for a door handle according to the present disclosure also includes: a door main body selectively opening an internal space; a side deco-bar covering a side edge portion of the door main body; a handle holder fixed to the side deco-bar; and a handle bar coupled to the handle holder and disposed a predetermined distance from the front panel.

A combining structure for a door handle according to the present disclosure also includes: a door main body selectively opening an internal space; a deco-bar covering an edge portion of the door main body; a handle holder fixed to the deco-bar; a front panel supported on the deco-bar and covering a front surface of the door main body; and a handle bar coupled to the handle holder and disposed a predetermined distance apart from the front panel.

### ADVANTAGEOUS EFFECTS

In a door handle according to the present disclosure, the strength of the door handle is improved, decoration of the door handle is made easier, and assembly is simplified, so that not only the exterior of the door handle but that of the door may be tastefully executed.

### BRIEF DESCRIPTION OF THE DRAWINGS

FIG. 1 is a partial perspective view of a door handle for a refrigerator according to embodiments of the present disclosure.

FIG. 2 is an exploded perspective view of a door handle for a refrigerator according to embodiments of the present disclosure.

FIG. 3 is a sectional view of FIG. 2 taken along line A-A′.

### BEST MODE FOR CARRYING OUT THE INVENTION

Reference will now be made in detail to preferred embodiments of a door handle for a refrigerator according to the present disclosure, with reference to the accompanying drawings.

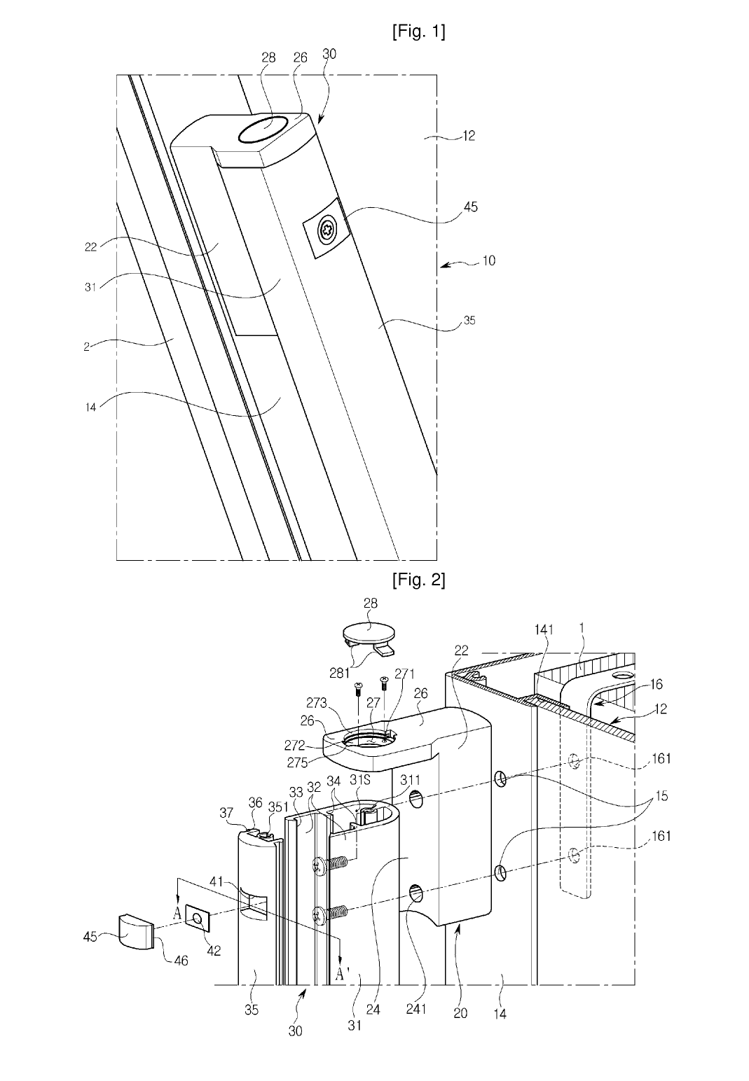

FIG. 1 is a partial perspective view of a door handle for a refrigerator according to embodiments of the present disclosure, FIG. 2 is an exploded perspective view of a door handle for a refrigerator according to embodiments of the present disclosure, and

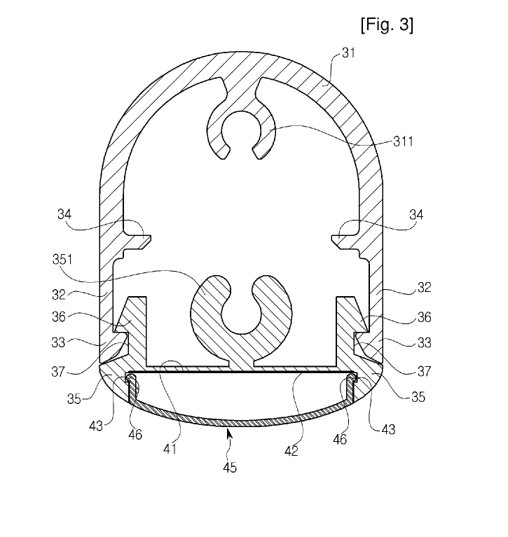

FIG. 3 is a sectional view of FIG. 2 taken along line A-A′.

It may easily be discerned that while the combining structure at the upper end of a door handle is shown in the diagrams, said structure may be equally applied as a mirroring structure to the lower end of a door handle. Also, while a right refrigeration compartment door of a refrigerator with the refrigeration compartment provided at the upper portion with twin french doors is exemplarily shown, it will be apparent that the door handle may also be easily applied to other types of doors with the same handle configuration.

Referring to each of the diagrams, a door 10 that opens and closes a storage compartment of a refrigerator has a front panel 12 defining its front surface. A door main body 1 (in FIG. 2) is provided to the inside of the front panel 12, and an insulating layer may be provided to the inside of the door main body 1. A door liner 2 for sealing the storage compartment with the door 10 is provided on the side surface of the door 10.

A deco-bar covers the side, upper, and lower surfaces of the door 10. A side deco-bar 14 forming a portion of the deco-bar is configured to seal a portion of the edge of the front panel 12. To mount a handle holder 20 described below, through-holes 15 are defined through the side deco-bar 14. A mounting bracket 16 in which through-holes 161 corresponding in location to the through-holes 15 are defined is provided at the inner surface of the side deco-bar 14. The mounting bracket 16 is fastened together with the handle holder 20 by means of screws to the side deco-bar 14. As a member that is fixed to the door main body 1, the mounting bracket 16 functions to fix the side deco-bar 14 and other components to the door main body 1.

A slot 141 is defined within the side deco-bar 14. By inserting the front panel 12 into the slot 141, the front panel 12 may be firmly supported.

The handle holder 20 is mounted to a portion on the front surface of the door 10 corresponding to the center of the side deco-bar 14. A holder body 22 is provided on the handle holder 20. The holder body 22 has a roughly elongated, hexahedral shape. A bar seat 24 is recessed lengthwise in the holder body 22. The bar seat 24 is formed on the surface opposite the surface on which the holder body 22 couples to the side deco-bar 14. A fastening hole 241 is defined in the bar seat 24 of the holder body 22.

A bar end fastener 26 protrudes from the upper portion of the holder body 22. The bar end fastener 26 is elongated and protruded in the direction opposite to the side deco-bar 14 on an end portion of the holder body 22. A fastening through-hole 27 is defined in the bar end fastener 26. A handle bar body 31 and handle cover 35 are fastened through the fastening through-hole 27. The fastening through-hole 27 is sealed with a cap 28. That is, the cap 28 seals the fastening through-hole 27 to prevent the coupling portion of the handle bar body 31 and handle cover 35 from being visible from the outside. The cap 28 is a circular plate with an elastic leg 281 provided at either end thereof to couple within the fastening through-hole 27 of the bar end fastener 26.

The handle bar 30 includes a mutually separating handle bar body 31 and handle cover 35. Of course, while the handle bar body 31 and the handle cover 35 may be integrally formed according to design requirements, according to preferred embodiments, the handle bar 30 is coupled to and supported by the handle holder 20 as a separate component.

The handle bar body 31 extends vertically or laterally along the door 10, and both ends thereof couple to the handle holder 20 and are supported on the door 10. The handle bar body 31 may be formed by drawing and extruding a metal material such as aluminum. Thus, the cross-section of the handle bar body 31 is formed uniformly across the length of the handle bar body 31.

With a semi-cylindrically shaped cross section, the handle bar body 31 is formed to extend a predetermined length in a straight line. That is, a catching rib 32 extends forward from either of the cross-sectional left and right sides of the handle bar body 31. The catching ribs 32 are formed thinner than the handle bar body 31 to be capable of elastic deformation outward from each other. Also, a catching tab 33 is formed at the leading edge of the catching rib 32. The catching ribs 32 and the catching tabs 33 extend along the length of the handle bar body 31.

A predetermined space 31S is defined within the handle bar body 31. Reinforcing ribs 34 protruding toward each other from the walls at either side of the space 31S (that is, at the points where catching ribs 32 extend forward from either sidewall of the handle bar body 31) extend along the length of the handle bar body 31. The reinforcing ribs 34 reinforce the handle bar body 31. Also, the reinforcing ribs 34 support either sidewall of the handle bar body 31, in order to prevent either sidewall of the handle bar body 31 from being separated due to the elasticity of the catching ribs 32.

The handle cover 35 is coupled to the catching ribs 32 of the handle bar body 31. The handle cover 35 has the same length as the handle bar body 31, to be coupled to the handle bar body 31 and reinforce the handle bar body 31. The handle cover 35 seals the front of the space 31S, and the front surface of the handle cover 35 forms the entire front surface of the handle bar 30. Also, catching ledges 36 that catch on the catching tabs 33 are formed along the length on either side at the rear of the handle cover 35.

The catching ledges 36 are defined by the catching channels 37 that are recessed along the length of the handle cover 35 in either side thereof. Because the recessed channels 37 are formed to extend a predetermined distance rearward, they innately have a certain amount of elasticity. The catching tabs 33 are supported and mounted by the catching ledges 36 in the catching channels 37.

A mounting groove 41 is defined in a front surface of the handle cover 35. A design sheet 42 may be inserted and placed in the mounting groove 41. A variety of items may be used for the design sheet 42. For example, an item with a color different from the handle bar body 31 or the handle cover 35 may be used, a different material may be used to provide an accentuating point on the door handle, and the brand name of the refrigerator or the manufacturer's logo may be printed.

Coupling recesses 43 (in FIG. 3) are defined in positions in the mounting groove 41 of the handle cover 35 offset from the front surface of the design sheet 42. The coupling recesses 43 are respectively defined facing each other in positions at the left and right sides of the mounting groove 41. A sealing cover 45 for protecting the design sheet 42 is installed in the mounting groove 41 in which the design sheet 42 is placed. The sealing cover 45 may be formed of a transparent material. The sealing cover 45 may, for example, be injection molded from a transparent PC material. Cover protrusions 46 for seating in the coupling recesses 43 are formed on either side of the sealing cover 45. The cover protrusions 46 are seated in the coupling recesses 43 to fix the sealing cover 45 in the mounting groove 41. The cover protrusions 46 are formed along the length at either side of the sealing cover 45.

Below, a combining structure of a refrigerator door handle according to the present embodiments with the above configuration will be described in detail.

First, a description of a combining process for a door handle according to the present embodiment will be provided. The design sheet 42 is mounted in the mounting groove 41 of the handle cover 35. Here, a double-sided tape or adhesive may be used to prevent the design sheet 42 from easily detaching from the mounting groove 41.

After the design sheet 42 is mounted in the mounting groove 41, the sealing cover 45 is mounted on the handle cover 35. For this, the cover protrusions 46 of the sealing cover 45 are mounted in the coupling recesses 43 of the mounting groove 41.

In this state, the handle cover 35 is assembled to the handle bar body 31. Of course, the mounting of the design sheet 42 or the sealing cover 45 may be performed with the handle cover 35 already assembled to the handle bar body 31. The catching ledges 36 on either side at the rear of the handle cover 35 catch on the catching tabs 33 formed on the catching ribs 32 of the handle bar body 31 and couple the handle cover 35 to the handle bar body 31.

When the handle cover 35 is assembled to the handle bar body 31, the catching ribs 32 are slightly deformed elastically and then restored to fix to the handle cover 35. In the present embodiment, the reinforcing ribs 34 are formed on the sides of either sidewall of the handle bar body 31 to prevent the sidewalls of the handle bar body 31 from being moved apart. In other words, even when the catching ribs 32 are elastically deformed during the process of catching on the catching ledges, the handle bar body 31 is unaffected by the elastic deformation of the catching ribs 32 at the points where the reinforcing ribs 34 are formed. Therefore, the points at which the reinforcing ribs 34 are formed on the handle bar body 31 provide support during the elastic deformation of the catching ribs 32. Accordingly, when the elasticity of the catching ribs 32 is increased, a firmer fastening with the catching ledges 36 can be realized.

The handle holder 20 is fastened to the side deco-bar 14. Specifically, with the holder body 22 of the handle holder 20 positioned on the outer surface of the side deco-bar 14 and the mounting bracket 16 positioned on the inner surface, the screws are passed through the through-holes 161 of the mounting bracket 16 and the through-holes 15 of the side deco-bar 14 and fastened to the fastening holes 241 of the holder body 22. Through performing the above, the handle holder 20 is fastened to the side deco-bar 14. Thus, the handle holder 20 may be fastened to the door main body 1.

Here, with the front panel 12 inserted in the slot 141, the position of the former can be supported.

Hereinafter, a detailed description of the combining of the handle bar 30 to the handle holder 20 will be provided.

Screws are passed through the fastening through-hole 27 of the bar end fastener 26 of the handle holder 20, and fastened to a fastening rib 351 of the handle cover 35 and a fastening rib of the handle bar body 31. For this end, a floor plate 272 defining the opening of the fastening through-hole 27 has fastening holes 271 defined therein to receive screws therein. Thus, the handle holder 20, handle bar body 31, and handle cover 35 are fastened together.

Next, the cap 28 is mounted on the fastening through-hole 27 of the bar end fastener 26 of the handle holder 20. The elastic leg 281 that extends laterally from the lower portion of the cap 28 is positioned above a recessed portion between the top of the floor plate 272 and a bottom of a ledge 273 so that it does not fall in. Of course, when inserting or detaching the elastic legs 281, the latter may be passed through inserting slots 275 to facilitate insertion and extrusion thereof.

The combining structure and combining method for door handles as described above allow door handles according to the present embodiments to be completely fastened.

The above-described preferred embodiments of combining structures for door handles may include the alternate exemplary embodiments below.

First, the handle holder 20, the side deco-bar 14, and the mounting bracket 16 have been described above as being combined through common screws. In this case, however, the fixing of the front panel 12 may be difficult. Taking this difficulty into account, the mounting bracket 16 and the side deco-bar 14 may first be combined with screws, after which the handle holder 20 and the side deco-bar 14 may be combined with separate screws, followed by the two assemblies being combined together.

Also, while the drawings show fastening holes formed in the bodies of the respective members, they are not limited thereto, and may be formed in fastening bosses and may be defined by fixed fan nuts.

The principles of the present disclosure may include embodiments not provided herein, that can easily be provided through extensions, modifications, deletions, and additions of elements within the spirit and scope of the principles of this disclosure, and it should thus be understood that such alternate embodiments shall fall within the spirit and scope of the principles of the present disclosure.

### MODE FOR THE INVENTION

The present disclosure may provide other embodiments that fall within the same range of principles as those of the present disclosure, in addition to the embodiments provided hereinabove. Such an embodiment will be described below.

While the design sheet 42, as indicated by its nomenclature, has been described as a sheet provided with a predetermined design formed thereon, it is not limited thereto, and may alternatively include any three-dimensional object such as a gem inserted and placed within. In this case, the range of users' aesthetic appreciation can be broadened, and the utilization of the inner space within the mounting groove 41 in which the three-dimensional object is placed is widened. Thus, the design sheet may be more aptly called a design part.

### INDUSTRIAL APPLICABILITY

According to the present disclosure, the strength of a handle bar is increased, so that when applied to a door handle, reliability is enhanced. Also, because a front panel may be separately provided from a door main body and the front panel and door handle assembly may be fixed together, working procedures at a manufacturing site are made easier. Moreover, because a design sheet can reliably be positioned on a separable handle bar, and because the design sheet is visible from the outside, the frontal design of a refrigerator can be constituted easily. Furthermore, by providing a three-dimensional design, design parameters are increased.

1. A door handle for a refrigerator, comprising:
a handle holder fixed to a side of a door of the refrigerator;
a handle bar body formed to extend in one direction, with extended ends thereof fixed to the handle holder and having a catching rib respectively formed at either side thereof; and
a handle cover disposed at a front of the handle bar body and catching on and supported by the catching ribs.

2. The door handle according to claim 1, further comprising a reinforcing rib formed on an inside of the catching rib in the handle bar body, to restrict elastic deforming of the catching rib.

3. The door handle according to claim 1, wherein the handle bar body is formed by being drawn and extruded.

4. The door handle according to claim 1, wherein the handle bar body is formed of an aluminum material.

5. The door handle according to claim 4, wherein the handle bar body comprises a fastening rib formed thereon, a screw inserted in the fastening rib parallel to the extending direction of the handle bar body.

6. The door handle according to claim 1, wherein the handle holder comprises:
a bar seat on which the handle bar body is seated; and
a bar end fastener formed at a position facing one of the extended ends of the handle bar body,
wherein the bar end fastener defines a fastening through-hole providing a region in which a screw fastening the handle cover or the handle bar body inserts.

7. The door handle according to claim 6, further comprising a cap covering the fastening through-hole.

8. The door handle according to claim 1, wherein the handle cover comprises:
a mounting groove defined in a side of a front surface thereof,
a design part disposed in the mounting groove; and
at least a semi-transparent sealing cover covering the mounting groove.

9. The door handle according to claim 8, wherein
the sealing cover comprises a cover protrusion respectively formed along either side thereof, and
the mounting groove comprises a coupling recess defined respectively at positions therein corresponding to the cover protrusion.

10. The door handle according to claim 1, wherein the handle bar body extends vertically along an edge of the door of the refrigerator.

11. A door handle for a refrigerator, comprising:
a handle holder fixed to a side of a door of the refrigerator;
a handle bar coupled to the handle holder;
a mounting groove provided through the handle bar being recessed at a predetermined location on the handle bar; and
a sealing cover covering the mounting groove, and through which light passes.

12. The door handle according to claim 11, wherein the mounting groove is opened in a frontal direction.

13. The door handle according to claim 11, wherein the handle bar comprises two separate components.

14. The door handle according to claim 13, wherein the two separate components are mutually caught and supported.

15. The door handle according to claim 11, further comprising a design part provided in an internal space defined in the mounting groove and covered by the sealing cover.

16. The door handle according to claim 15, wherein the design part is a design sheet.

17. A combining structure for a door handle, comprising:
a door main body selectively opening an internal space;
a deco-bar covering an edge portion of the door main body;
a handle holder fixed to the deco-bar;
a front panel supported on the deco-bar and covering a front surface of the door main body; and
a handle bar coupled to the handle holder and disposed a predetermined distance apart from the front panel.

18. The combining structure according to claim 17, wherein the front panel is supported in a slot defined in the deco-bar.

19. The combining structure according to claim 17, further comprising:
a mounting groove provided at a predetermined position on the handle bar; and
a design part seated within the mounting groove.

20. The combining structure according to claim 17, wherein the deco-bar is a side deco-bar covering a side edge of the door main body.

21. The combining structure according to claim 17, further comprising a mounting bracket fastened respectively to the door main body and the side deco-bar.

22. A combining structure for a door handle, comprising:
a door main body selectively opening an internal space;
a side deco-bar covering a side edge portion of the door main body;
a mounting bracket mounting the side deco-bar to the door main body;
a handle holder fixed to the side deco-bar; and
a handle bar coupled to the handle holder, for a user to grasp,
wherein the handle bar comprises
a handle bar body; and
a separate handle cover covering a front of the handle bar body.

23. The combining structure according to claim 22, wherein the handle cover is caught and fixed on the handle bar body.

24. The combining structure according to claim 22, wherein the handle cover defines a mounting groove recessed a predetermined depth therein, to provide a design part in the handle cover.

25. A combining structure for a door handle, comprising:
a door main body selectively opening an internal space;
a side deco-bar covering a side edge portion of the door main body;
a handle holder fixed to the side deco-bar; and
a handle bar coupled to the handle holder and disposed a predetermined distance from the front panel.
